(19) United States
(12) Patent Application Publication
(10) Pub. No.: US 2025/0112553 A1
(43) Pub. Date: Apr. 3, 2025

(54) HIGH-EFFICIENCY CONVERTER WITH A CONFIGURABLE SWITCHING ELEMENT

(71) Applicant: STMicroelectronics International N.V., Geneva (CH)

(72) Inventors: Claudio Bona, Pieve del Cairo (IT); Kien Beng Tan, Singapore (SG)

(21) Appl. No.: 18/480,340

(22) Filed: Oct. 3, 2023

(51) Int. Cl. H02M 3/158; H02J 7/00; H02M 1/00

(52) U.S. Cl. CPC H02M 3/158; H02J 7/007; H02M 1/0054; H02J 2207/20

(57) ABSTRACT

According to an embodiment, a method of operating an M-level buck converter in a battery charging circuit is provided. The M-level buck converter includes 2×N×(M−1) number of transistors. M and N are greater than one. The method includes operating the M-level buck converter in a first mode of the battery charging circuit corresponding to a high-current charge mode. The method further includes operating the M-level buck converter in a second mode of the battery charging circuit corresponding to a low-current charge mode. In the first mode, 2×N×(M−1) number of transistors are switched ON and OFF. In the second mode, 2×(M−1) number of transistors are switched ON and OFF and 2×N×(M−1)−2×(M−1) number of transistors are fully deactivated.

### TECHNICAL FIELD

The present disclosure generally relates to power converters and, in particular embodiments, to a high-efficiency configurable switching element in a converter.

### BACKGROUND

Generally, portable electronic devices use batteries to support various device functionalities, such as cameras, touchscreens, and data connections. Chargers facilitate the quick charging of these batteries. Conventional synchronous buck-based battery charging circuits face limitations in fully harnessing high input power due to their maximum efficiency constraints. The challenge for designers of portable electronics lies in devising a high-efficiency battery charging circuit that fits within a compact form factor while using high input power to achieve rapid and efficient charging.

Generally, battery charging circuit losses result from switch resistances, switching charge losses, reverse recovery losses, gate turn-on and turn-off losses, and losses across body diodes during dead time. Switch resistance losses vary with load due to the current square relationship, while switch charge losses depend on switching frequency and input transistor capacitance. Reducing the on-resistance of a transistor by increasing the transistor area helps mitigate switch resistance losses but disadvantageously raises input capacitance and switching charge losses. Balancing these factors requires an adaptive solution for an optimal trade-off.

### SUMMARY

Technical advantages are generally achieved by embodiments of this disclosure, which describe a high-efficiency configurable switching element in a converter.

A first aspect relates to a method of operating an M-level buck converter of a battery charging circuit. The M-level buck converter includes 2×N×(M−1) number of transistors. M and N are greater than one. The method includes operating the M-level buck converter in a first mode of the battery charging circuit corresponding to a high-current charge mode. In the first mode, 2×N×(M−1) number of transistors are switched ON and OFF. The method further includes operating the M-level buck converter in a second mode of the battery charging circuit corresponding to a low-current charge mode. In the second mode, 2×(M−1) number of transistors are switched ON and OFF and 2×N×(M−1)−2×(M−1) number of transistors are fully deactivated.

A second aspect relates to an M-level buck converter of a battery charging circuit, M being greater than one, the M-level buck converter includes 2×N×(M−1) number of transistors, N being greater than one. The M-level buck converter is configured to operate in a first mode and a second mode. The first mode corresponds to a high-current charge mode of the battery charging circuit. The second mode corresponds to a low-current charge mode of the battery charging circuit. In the first mode, 2×N×(M−1) number of transistors are switched ON and OFF. In the second mode, 2×(M−1) number of transistors are switched ON and OFF, and 2×N×(M−1)−2×(M−1) number of transistors are fully deactivated.

A third aspect relates to a system. The system includes a battery and a battery charging circuit. The battery charging circuit includes an M-level buck converter, M being greater than one. The M-level buck converter includes 2×N×(M−1) number of transistors, N being greater than one. The M-level buck converter is configured to operate in a first mode and a second mode. The first mode corresponds to a high-current charge mode of the battery charging circuit. The second mode corresponds to a low-current charge mode of the battery charging circuit. In the first mode, 2×N×(M−1) number of transistors are switched ON and OFF. In the second mode, 2×(M−1) number of transistors are switched ON and OFF, and 2×N×(M−1)−2×(M−1) number of transistors are fully deactivated.

A fourth aspect relates to a method of operating an M-level buck converter in a battery charging circuit, the M-level buck converter comprising 2×N×(M−1) number of transistors, M and N being greater than one. The method includes operating the M-level buck converter in a first mode of the battery charging circuit corresponding to a high-current charge mode, wherein the 2×N×(M−1) number of transistors are switched ON and OFF. The method further includes operating the M-level buck converter in a second mode of the battery charging circuit corresponding to a low-current charge mode, wherein at least 2×(M−1) but less than 2×N×(M−1) number of transistors are switched ON and OFF.

A fifth aspect relates to an M-level buck converter of a battery charging circuit, M being greater than one, the M-level buck converter includes 2×N×(M−1) number of transistors, N being greater than one. The M-level buck converter is configured to operate in a first mode and a second mode. The first mode corresponds to a high-current charge mode of the battery charging circuit. The second mode corresponds to a low-current charge mode of the battery charging circuit. In the first mode, 2×N×(M−1) number of transistors are switched ON and OFF. In the second mode, at least 2×(M−1) but less than 2×N×(M−1) number of transistors are switched ON and OFF.

A third aspect relates to a system. The system includes a battery and a battery charging circuit. The battery charging circuit includes an M-level buck converter, M being greater than one. The M-level buck converter includes 2×N×(M−1) number of transistors, N being greater than one. The M-level buck converter is configured to operate in a first mode and a second mode. The first mode corresponds to a high-current charge mode of the battery charging circuit. The second mode corresponds to a low-current charge mode of the battery charging circuit. In the first mode, 2×N×(M−1) number of transistors are switched ON and OFF. In the second mode, at least 2×(M−1) but less than 2×N×(M−1) number of transistors are switched ON and OFF.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a schematic of a two-level (2L) step-down (buck) converter;

FIG. 2 is a schematic of a three-level (3L) buck converter;

FIG. 3 is a schematic of an embodiment 2L buck converter;

FIG. 4 is a schematic of an embodiment 3L buck converter;

FIG. 5 is a block diagram of an embodiment system; and

FIG. 6 is a flow chart of an embodiment method for operating the system in FIG. 5 with an M-level buck converter.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of a switching regulator implemented as a buck converter, it should also be appreciated that these inventive aspects may also apply to other types of switched-mode power supplies (SMPS), such as a boost converter, a buck-boost converter, or the like. In particular, this disclosure may similarly apply to two-level (2L), three-level (3L), or any M-L buck converter, M being an integer greater than one.

Embodiments of this disclosure provide an improved multi-level buck converter with a configurable switching element. The multi-level buck converter may be part of a battery charging circuit in an electronic device. Conventionally, in a traditional M-level buck converter (M being an integer greater than one), the number of transistors equals 2×(M−1). In embodiments, an M-level buck converter is proposed where the number of transistors equals 2×N×(M−1), with N being an integer greater than one. For each transistor in the switching element of the traditional multi-level buck converter, the proposed multi-level buck converter includes N number of transistors. The transistor area for each transistor in the proposed multi-level buck converter is a factor of 1/N the transistor area of the traditional multi-level buck converter.

Aspects of this disclosure provide a controller that operates the M-level buck converter in at least two modes. During the first mode, the M-level buck converter of the battery charging circuit operates in a high-current charging mode. During the first mode (i.e., the high-current charging mode), the full set of transistors (i.e., 2×N×(M−1)) of the proposed M-level buck converter are configured to operate between the ON and OFF states. During the second mode, the M-level buck converter operates in a low-current charging mode. During the second mode (i.e., the low-current charging mode), a subset of transistors equal to the original number of transistors (i.e., 2×(M−1)) in a traditional multi-level buck converter is configured to operate between the ON and OFF states while the remaining number of transistors in the proposed M-level buck converter are fully deactivated. These and other details are further detailed below.

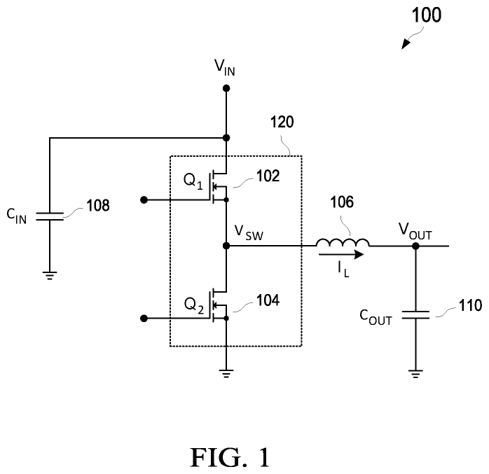

FIG. 1 illustrates a schematic of a two-level (2L) step-down (buck) converter 100. The traditional 2L buck converter 100 is a type of switched-mode power supply that typically includes a switching element 120, an inductor (L) 106, an optional input capacitor (C_{IN}) 108, and an optional output capacitor (C_{OUT}) 110.

The switching element 120 includes a first transistor (Q₁) 102 (i.e., the high-side switch) and a second transistor (Q₂) 104 (i.e., the low-side switch). The first transistor (Q₁) 102 is coupled between the input source (V_{IN}) and the switching node (SW). The second transistor (Q₂) 104 is coupled between the switching node (SW) and reference ground. The first transistor (Q₁) 102 and the second transistor (Q₂) 104 can be of the metal-oxide silicon field-effect transistors (MOSFETs) type. The first transistor (Q₁) 102 and the second transistor (Q₂) 104 can be n-channel type MOSFETs.

The inductor (L) 106 is coupled between the switching node (SW) and an output terminal of the traditional 2L buck converter 100, typically coupled to the output capacitor (C_{OUT}) 110. Optionally, an input capacitor (C_{IN}) 108 is coupled between the input source (V_{IN}) and reference ground.

A controller in a battery charging circuit can provide complimentary control signals with equal duty cycles to the gate terminals of the first transistor (Q₁) 102 and the second transistor (Q₂) 104. During the ON period of the first transistor (Q₁) 102, the second transistor (Q₂) 104 is in the OFF condition, and the inductor (L) 106 is charging and providing current (I_{L}) to the output terminal of the traditional 2L buck converter 100. In contrast, during the ON period of the second transistor (Q₂) 104, the first transistor (Q₁) 102 is in the OFF condition, and the inductor (L) 106 is discharging and providing current (I_{L}) to the output terminal of the traditional 2L buck converter 100.

As such, the switching node voltage (V_{SW}) at the switching node (SW) alternates between the voltage at the input source (V_{IN}) and reference ground. The controlled ON and OFF switching of the first transistor (Q₁) 102 and the second transistor (Q₂) 104 produce a fixed duty-cycle square waveform that, when filtered out by the inductor (L) 106 and output capacitor (C_{OUT}) 110, provides an output voltage (V_{OUT}) for a load.

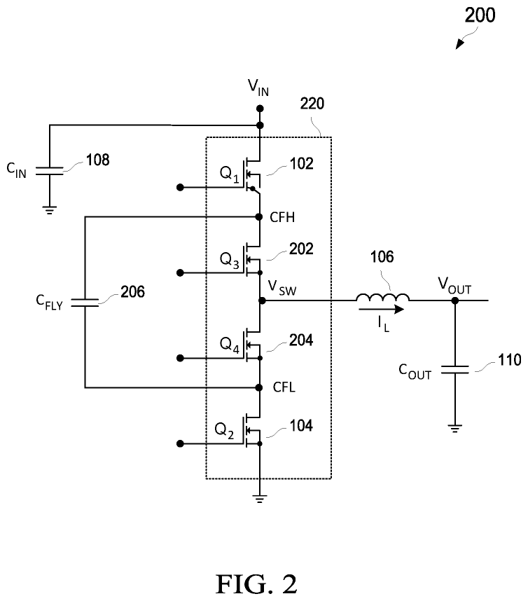

FIG. 2 illustrates a schematic of a three-level (3L) buck converter 200. The traditional 3L buck converter 200, in addition to the components previously described with the traditional 2L buck converter 100 and not repeated, includes a third transistor (Q₃) 202, a fourth transistor (Q₄) 204, and a switched flying capacitor (C_{FLY}) 206.

The switching element 220 of the traditional 3L buck converter 200 includes the first transistor (Q₁) 102, the second transistor (Q₂) 104, the third transistor (Q₃) 202, and the fourth transistor (Q₄) 204. The third transistor (Q₃) 202 is coupled between the first transistor (Q₁) 102 and the fourth transistor (Q₄) 204. The fourth transistor (Q₄) 204 is coupled between the third transistor (Q₃) 202 and the second transistor (Q₂) 104.

The switched flying capacitor (C_{FLY}) 206 is coupled between (i) the flying capacitor high node (CFH) (i.e., common terminal between third transistor (Q₃) 202 and first transistor (Q₁) 102) and (ii) the flying capacitor low node (CFL) (i.e., common terminal between fourth transistor (Q₄) 204 and the second transistor (Q₂) 104).

The third transistor (Q₃) 202 and the fourth transistor (Q₄) 204 can be of the metal-oxide silicon field-effect transistors (MOSFETs) type. The third transistor (Q₃) 202 and the fourth transistor (Q₄) 204 can be n-channel type MOSFETs.

The drain terminal of the third transistor (Q₃) 202 is coupled to the source terminal of the first transistor (Q₁) 102; the drain terminal of the fourth transistor (Q₄) 204 is coupled to the source terminal of the third transistor (Q₃) 202; and the drain terminal of the second transistor (Q₂) 104 is coupled to the source terminal of the second transistor (Q₂) 104. The source terminal of the second transistor (Q₂) 104 is coupled to the reference ground (i.e., electric ground, reference potential node) of the traditional 3L buck converter.

Like the traditional 2L buck converter 100, a controller provides the first complementary control signals with equal duty cycles to the gate terminals of the first transistor (Q₁) 102 and the second transistor (Q₂) 104. In addition, in the traditional 3L buck converter 200, the controller provides second complementary control signals with equal duty cycles to the gate terminals of the third transistor (Q₃) 202 and the fourth transistor (Q₄) 204. The first and second complementary control signals are 180 degrees out of phase.

The switched flying capacitor (C_{FLY}) 206 is balanced at half the voltage of the input source (V_{IN}), resulting in the switching node voltage (V_{SW}) at the switching node (SW) alternating between the voltage at the input source (V_{IN}), half the voltage at the input source (V_{IN}) (i.e., V_{IN}/2), and reference ground (0 V).

Generally, losses in a battery charging circuit result from switch resistances, switching charge losses, reverse recovery losses, gate turn-on and turn-off losses, and losses across body diodes during dead time.

Typically, when a transistor is in its ON state (i.e., active or conducting state), the current flowing through the transistor encounters resistance in the semiconductor material, leading to power dissipation in the form of heat. Switch resistance losses (i.e., conduction losses) vary with load due to the current square relationship (i.e., P=I²×R, where P is the power dissipation, I is the current, and R is the resistance).

Increasing a transistor's area (e.g., increasing the width (W) of the transistor channel) helps mitigate switch resistance loss due to the reduction in the transistor's on-resistance during its conducting state (i.e., R_{ds}(ON)), as R_{ds}(ON)∝1/W.

In contrast, switch charge losses (i.e., dynamic losses) depend on the switching frequency and the transistor's input capacitance. Typically, switch charge losses occur when the transistors operate between ON and OFF states. The losses result from the energy required to charge and discharge the transistor's capacitance during the transition from one state to another.

Disadvantageously, enlarging the transistor's area to reduce the resistance loss results in an increase in the transistor's capacitance, which causes an increase in the switching charge losses. Likewise, reducing the transistor's area to reduce the switching charge losses increases the resistance losses, which causes an increase in the switch resistance losses.

When a battery charging circuit operates at a high-current charge mode, the battery is being charged at a relatively high current rate. This mode is typically used when the battery needs to be charged quickly, such as when a device is low on power and needs to be operational as soon as possible. During the high-current charge mode, the switch resistance losses dominate the losses in the battery charging circuit.

When a battery charging circuit operates at a low-current charge mode, the battery is typically partially or near fully charged, or the charging rate is reduced to avoid excess heat or prolong the battery's life span. During this mode, the battery is charged at a relatively low current rate (e.g., trickle charging or maintaining battery levels for an extended period). During the low-current charge mode, the switch charge losses dominate the losses in the battery charging circuit.

Embodiments of this disclosure improve the traditional buck converter, as shown, for example, in FIGS. 1 and 2, to address these deficiencies in the conventional battery charging circuits. In various embodiments, a configurable switching element is disclosed for a converter that includes an adjustable effective transistor area based on the type of dominant losses during the mode of the battery charging circuit.

For example, this disclosure provides a buck converter with a first effective transistor area during the high-current charge mode and a second effective transistor area during the low-current charge mode. In such embodiments, the first effective transistor area is greater than the second effective transistor area. Accordingly, the transistor's resistance is reduced during the high-current charge mode, while the transistor's capacitance is reduced during the low-current charge mode. Advantageously, the proposed configurable switching element provides reduced switch resistance losses during the high-current charge mode and reduced switch charge losses during the low-current charge mode.

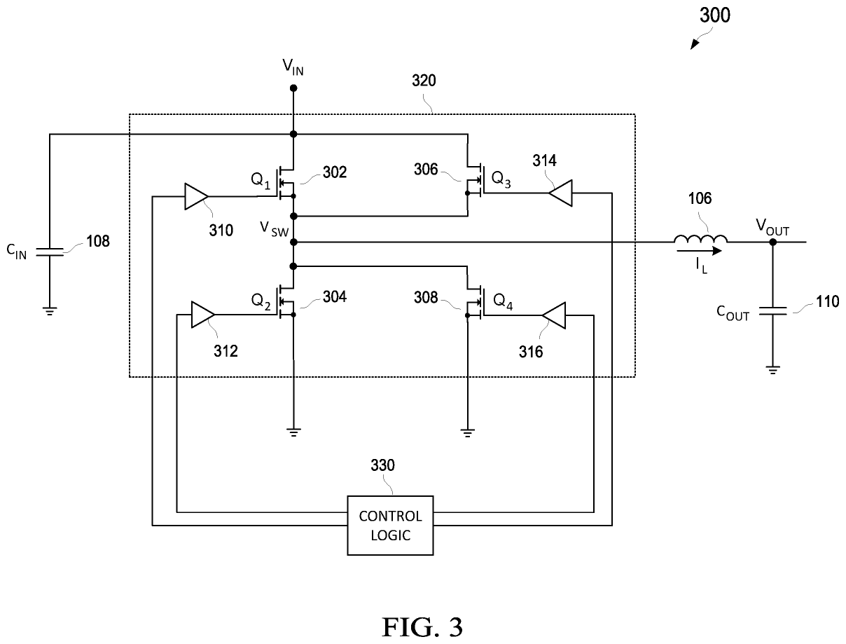

FIG. 3 illustrates a schematic of an embodiment 2L buck converter 300. In the 2L buck converter 300, the switching element 120 of the traditional 2L buck converter 100 is replaced by the switching element 320. In embodiments, the 2L buck converter 300 is a component within a battery charging circuit.

The switching element 320 includes a first transistor (Q₁) 302, a second transistor (Q₂) 304, a third transistor (Q₃) 306, and a fourth transistor (Q₄) 308. Specifically, the first transistor (Q₁) 102 of the traditional 2L buck converter 100 is replaced by the first transistor (Q₁) 302 and the third transistor (Q₃) 306. Further, the second transistor (Q₂) 104 of the traditional 2L buck converter 100 is replaced by the second transistor (Q₂) 304 and the fourth transistor (Q₄) 308.

Optionally, switching element 320 includes a first gate driver 310, a second gate driver 312, a third gate driver 314, and a fourth gate driver 316. The output terminal of the first gate driver 310 is coupled to the gate terminal of the first transistor (Q₁) 302, the output terminal of the second gate driver 312 is coupled to the gate terminal of the second transistor (Q₂) 304, the output terminal of the third gate driver 314 is coupled to the gate terminal of the third transistor (Q₃) 306, and the output terminal of the fourth gate driver 316 is coupled to the gate terminal of the fourth transistor (Q₄) 308.

In embodiments, the control logic 330 is configured to control the operation of the switching element 320 of the 2L buck converter 300. In embodiments, the control logic 330 controls the operation of the first transistor (Q₁) 302, the second transistor (Q₂) 304, the third transistor (Q₃) 306, and the fourth transistor (Q₄) 308 using output signals provided to, for example, the first gate driver 310, the second gate driver 312, the third gate driver 314, and the fourth gate driver 316, respectively.

In embodiments, the first transistor (Q₁) 302 and the third transistor (Q₃) 306 are configured such that the surface area of each transistor is half the surface area of the first transistor (Q₁) 102 of the traditional 2L buck converter 100. In embodiments, the first transistor (Q₁) 302 and the third transistor (Q₃) 306 are configured such that the surface area of each transistor is a non-even or even fraction of the surface area of the first transistor (Q₁) 102 of the traditional 2L buck converter 100. In such embodiments, the first transistor (Q₁) 302 and the third transistor (Q₃) 306 are configured such that the summation of the surface area of the two transistors is equal to the surface area of the first transistor (Q₁) 102 of the traditional 2L buck converter 100.

For example, in an embodiment, the surface area of the first transistor (Q₁) 302 equals T/N of the surface area of the first transistor (Q₁) 102 of the traditional 2L buck converter 100, where Nis an integer greater than one and T is an integer greater than 0. The surface area of the third transistor (Q₃) 306 equals N−T/N of the surface area of the first transistor (Q₁) 102 of the traditional 2L buck converter 100.

As another example, in an embodiment, the surface area of the first transistor (Q₁) 302 equals half the surface area of the first transistor (Q₁) 102 of the traditional 2L buck converter 100 and the surface area of the third transistor (Q₃) 306 equals half the surface area of the first transistor (Q₁) 102 of the traditional 2L buck converter 100.

In embodiments, the selection of the ratio for each of the first transistor (Q₁) 302 and the third transistor (Q₃) 306 to the first transistor (Q₁) 102 of the traditional 2L buck converter 100 is determined based on the load profile of the converter-assuming that the sum of the surface area of the first transistor (Q₁) 302 and the third transistor (Q₃) 306 equals the surface area of the first transistor (Q₁) 102.

In embodiments, the second transistor (Q₂) 304 and the fourth transistor (Q₄) 308 are configured such that the surface area of each transistor is half the surface area of the second transistor (Q₂) 104 of the traditional 2L buck converter 100. In embodiments, the second transistor (Q₂) 304 and the fourth transistor (Q₄) 308 are configured such that the surface area of each transistor is a non-even or even fraction of the surface area of the second transistor (Q₂) 104 of the traditional 2L buck converter 100. In such embodiments, the second transistor (Q₂) 304 and the fourth transistor (Q₄) 308 are configured such that the summation of the surface area of the two transistors is equal to the surface area of the second transistor (Q₂) 104 of the traditional 2L buck converter 100.

For example, in an embodiment, the surface area of the second transistor (Q₂) 304 equals T/N of the surface area of the second transistor (Q₂) 104 of the traditional 2L buck converter 100, where Nis an integer greater than one and T is an integer greater than 0. The surface area of the fourth transistor (Q₄) 308 equals N−T/N of the surface area of the second transistor (Q₂) 104 of the traditional 2L buck converter 100.

As another example, in an embodiment, the surface area of the second transistor (Q₂) 304 equals half the surface area of the second transistor (Q₂) 104 of the traditional 2L buck converter 100 and the surface area of the fourth transistor (Q₄) 308 equals half the surface area of the second transistor (Q₂) 104 of the traditional 2L buck converter 100.

In embodiments, the selection of the ratio for each of the second transistor (Q₂) 304 and the fourth transistor (Q₄) 308 to the second transistor (Q₂) 104 of the traditional 2L buck converter 100 is determined based on the load profile of the converter-assuming that the sum of the surface area of the second transistor (Q₂) 304 and the fourth transistor (Q₄) 308 equals the surface area of the second transistor (Q₂) 104.

In embodiments, the control terminals of the first transistor (Q₁) 302, the second transistor (Q₂) 304, the third transistor (Q₃) 306, and the fourth transistor (Q₄) 308 are independently controlled to fully deactivate a subset of the transistors using the control logic 330 based on the mode of the battery charging circuit.

In embodiments, the 2L buck converter 300 is configurable to operate in at least two modes. In an embodiment, the first mode corresponds to the operation of the battery charging circuit during the high-current charging mode, and the second mode corresponds to the operation of the battery charging circuit during the low-current charging mode.

In the first mode, the switch resistance losses dominate. Thus, it would be advantageous to configure the switching element 320 to decrease the on-resistance of the high-side and low-side transistors in the switching element 320 of the 2L buck converter 300. As discussed above, the width of the transistor channel is inversely proportional to the transistor's on-resistance. Accordingly, in the first mode, the control logic 330 provides control signals to operate the first transistor (Q₁) 302, the second transistor (Q₂) 304, the third transistor (Q₃) 306, and the fourth transistor (Q₄) 308 between ON and OFF states.

In this mode, the high-side and low-side transistors of the 2L buck converter 300 have the same effective transistor area as the high-side and the low-side transistors of the traditional 2L buck converter 100. Accordingly, the effective resistance of the high-side transistors in the 2L buck converter 300 is at its maximum configuration and equal to the resistance of the high-side transistor in the traditional 2L buck converter 100. Likewise, the effective resistance of the low-side transistors in the 2L buck converter 300 is at its maximum configuration and equal to the resistance of the low-side transistor in the traditional 2L buck converter 100.

In the second mode, the switch charge losses dominate. Thus, it would be advantageous to configure the switching element 320 to decrease the capacitance (e.g., gate-to-source capacitance (C_{gs}), gate-to-drain capacitance (C_{gd}), input capacitance (Cᵢₛₛ), output capacitance (Cₒₛₛ), reverse transfer capacitance (Cᵣₛₛ), etc.) of the high-side and low-side transistors of the 2L buck converter 300. As the area of the gate capacitance is directly proportional to the area of the gate electrode. Accordingly, in the second mode, the control logic 330 provides control signals to operate the first transistor (Q₁) 302 and the second transistor (Q₂) 304 between ON and OFF states and fully deactivate the third transistor (Q₃) 306 and the fourth transistor (Q₄) 308.

In this mode, the high-side and low-side transistors of the 2L buck converter 300 have a fraction (e.g., half) of the effective transistor area as the high-side and the low-side transistors of the traditional 2L buck converter 100. Accordingly, the effective capacitance of the high-side transistor in the 2L buck converter 300 is significantly reduced compared to the high-side transistor in the traditional 2L buck converter 100. Likewise, the effective capacitance of the low-side transistor in the 2L buck converter 300 is significantly reduced compared to the low-side transistor in the traditional 2L buck converter 100.

Advantageously, during the high-current charging mode, the transistor area is at its maximum, the transistor's ON resistance is at its minimum, and the switch resistance losses are at their minimum. Further, during the low-current charging mode, the transistor area is at its minimum, the transistor's capacitance is at its minimum, and the switch charge losses are at their minimum.

Thus, the control logic 330 can selectively operate the switching element 320 based on the mode of the battery charging circuit to have the most efficient operating conditions without sacrificing efficiency in one mode for the other.

It should be noted that in FIG. 3, the switching element 320 of the 2L buck converter 300 is shown to include two high-side transistors (i.e., the first transistor (Q₁) 302 and the third transistor (Q₃) 306) instead of the single first transistor (Q₁) 102 in the switching element 120 of the traditional 2L buck converter 100. Likewise, the switching element 320 of the 2L buck converter 300 is shown to include two low-side transistors (i.e., the second transistor (Q₂) 304 and the fourth transistor (Q₄) 308) instead of the single second transistor (Q₂) 104 in the switching element 120 of the traditional 2L buck converter 100. However, it should be appreciated that the number of high-side transistors and low-side transistors in the switching element 320 is non-limiting.

For example, although the switching element 320 is shown to have two of each of the high-side and low-side transistors, embodiments with a switching element with N number of high-side and low-side transistors, where Nis an integer greater than one are similarly contemplated. In such embodiments, each transistor within the N number of transistors has a common drain and a common source. In such embodiments, the transistor area of each transistor can be equal to, for example, 1/N the transistor area of the high-side or low-side transistor in the switching element 120 of the traditional 2L buck converter 100. It is noted that the transistor area for each transistor does not have to be equal to 1/N and different surface areas for the transistors in each set are similarly contemplated.

In embodiments, control logic 330 is configured to operate all N number of transistors between ON and OFF states in the first mode, and fewer than all N number of transistors for each of the high-side and low-side transistors between the ON and OFF states in the second mode, while fully deactivating the other transistors.

For example, in an embodiment, where each of the transistors in the traditional M-level buck converter (M being greater than two) is replaced by N number of transistors, the total number of transistors in the improved M-level buck converter is N×M. During the first mode, all N×M number of transistors are activated and switch between ON and OFF states based on the switching mode operation of the switching converter. However, during the second mode, based on the load profile, T number of transistors are activated and switch between ON and OFF states based on the switching mode operation of the switching converter, where T is less than N×M. In the second mode, N×M−T number of transistors are fully deactivated and do not participate in the switching operation.

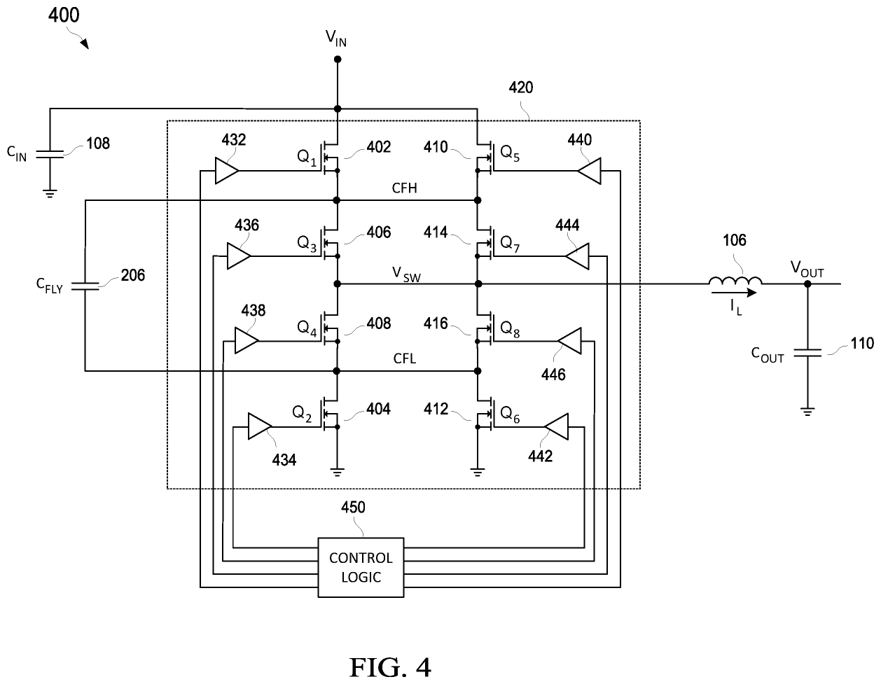

FIG. 4 illustrates a schematic of an embodiment 3L buck converter 400. In the 3L buck converter 400, the switching element 220 of the traditional 3L buck converter 200 is replaced by the switching element 420. In embodiments, the 3L buck converter 400 is a component within a battery charging circuit.

The switching element 420 includes the first transistor (Q) 402, the second transistor (Q₂) 404, the third transistor (Q₃) 406, the fourth transistor (Q₄) 408, a fifth transistor (Q₅) 410, a sixth transistor (Q₆) 412, a seventh transistor (Q₇) 414, and an eighth transistor (Q₈) 416.

In embodiments, the first transistor (Q₁) 102 of the traditional 3L buck converter 200 is replaced by the first transistor (Q) 402 and the fifth transistor (Q₅) 410; the second transistor (Q₂) 104 of the traditional 3L buck converter 200 is replaced by the second transistor (Q₂) 404 and the sixth transistor (Q₆) 412; the third transistor (Q₃) 202 of the traditional 3L buck converter 200 is replaced by the third transistor (Q₃) 406 and the seventh transistor (Q₇) 414; and the fourth transistor (Q₄) 204 of the traditional 3L buck converter 200 is replaced by the fourth transistor (Q₄) 408 and the eight transistor (Q₈) 416.

Optionally, switching element 420 includes a first gate driver 432, a second gate driver 434, a third gate driver 436, a fourth gate driver 438, a fifth gate driver 440, a sixth gate driver 442, a seventh gate driver 444, and an eight gate driver 446. The output terminal of the first gate driver 432 is coupled to the gate terminal of the first transistor (Q) 402, the output terminal of the second gate driver 434 is coupled to the gate terminal of the second transistor (Q₂) 404, the output terminal of the third gate driver 436 is coupled to the gate terminal of the third transistor (Q₃) 406, the output terminal of the fourth gate driver 438 is coupled to the gate terminal of the fourth transistor (Q₄) 408, the output terminal of the fifth gate driver 440 is coupled to the gate terminal of the fifth transistor (Q₅) 410, the output terminal of the sixth gate driver 442 is coupled to the gate terminal of the sixth transistor (Q₆) 412, the output terminal of the seventh gate driver 444 is coupled to the gate terminal of the seventh transistor (Q₇) 414, and the output terminal of the eight gate driver 446 is coupled to the gate terminal of the fourth transistor (Q₈) 416.

In embodiments, the control logic 450 controls the operation of the switching element 420 of the 3L buck converter 400. In embodiments, the control logic 450 controls the operation of the first transistor (Q₁) 402, the second transistor (Q₂) 404, the third transistor (Q₃) 406, the fourth transistor (Q₄) 408, the fifth transistor (Q₅) 410, the sixth transistor (Q₆) 412, the seventh transistor (Q₇) 414, and the eighth transistor (Q₈) 416 using output signals provided to the first gate driver 432, the second gate driver 434, the third gate driver 436, the fourth gate driver 438, the fifth gate driver 440, the sixth gate driver 442, the seventh gate driver 444, and the eight gate driver 446, respectively.

In embodiments, the first transistor (Q₁) 402 and the fifth transistor (Q₅) 410 are configured such that the surface area of each transistor is half the surface area of the first transistor (Q₁) 102 of the traditional 3L buck converter 200. In embodiments, the first transistor (Q₁) 402 and the fifth transistor (Q₅) 410 are configured such that the surface area of each transistor is a non-even or even fraction of the surface area of the first transistor (Q₁) 102 of the traditional 3L buck converter 200. In such embodiments, the first transistor (Q₁) 402 and the fifth transistor (Q₅) 410 are configured such that the summation of the surface area of the two transistors is equal to the surface area of the first transistor (Q₁) 102 of the traditional 3L buck converter 200.

For example, in an embodiment, the surface area of the first transistor (Q₁) 402 equals T/N of the surface area of the first transistor (Q₁) 102 of the traditional 3L buck converter 200, where N is an integer greater than one and T is an integer greater than 0. The surface area of the fifth transistor (Q₅) 410 equals N−T/N of the surface area of the first transistor (Q₁) 102 of the traditional 3L buck converter 200.

As another example, in an embodiment, the surface area of the first transistor (Q₁) 402 equals half the surface area of the first transistor (Q₁) 102 of the traditional 3L buck converter 200 and the surface area of the fifth transistor (Q₅) 410 equals half the surface area of the first transistor (Q) 102 of the traditional 3L buck converter 200.

In embodiments, the selection of the ratio for each of the first transistor (Q) 402 and the fifth transistor (Q₅) 410 to the first transistor (Q) 102 of the traditional 3L buck converter 200 is determined based on the load profile of the converter-assuming that the sum of the surface area of the first transistor (Q) 402 and the fifth transistor (Q₅) 410 equals the surface area of the first transistor (Q) 102.

In embodiments, the second transistor (Q₂) 404 and the sixth transistor (Q₆) 412 are configured such that the surface area of each transistor is half the surface area of the second transistor (Q₂) 104 of the traditional 3L buck converter 200. In embodiments, the second transistor (Q₂) 404 and the sixth transistor (Q₆) 412 are configured such that the surface area of each transistor is a non-even or even fraction of the surface area of the second transistor (Q₂) 104 of the traditional 3L buck converter 200. In such embodiments, the second transistor (Q₂) 404 and the sixth transistor (Q₆) 412 are configured such that the summation of the surface area of the two transistors is equal to the surface area of the second transistor (Q₂) 104 of the traditional 3L buck converter 200.

For example, in an embodiment, the surface area of the second transistor (Q₂) 404 equals T/N of the surface area of the second transistor (Q₂) 104 of the traditional 3L buck converter 200, where N is an integer greater than one and T is an integer greater than 0. The surface area of the sixth transistor (Q₆) 412 equals N−T/N of the surface area of the second transistor (Q₂) 104 of the traditional 3L buck converter 200.

As another example, in an embodiment, the surface area of the second transistor (Q₂) 404 equals half the surface area of the second transistor (Q₂) 104 of the traditional 3L buck converter 200 and the surface area of the sixth transistor (Q₆) 412 equals half the surface area of the second transistor (Q₂) 104 of the traditional 3L buck converter 200.

In embodiments, the selection of the ratio for each of the second transistor (Q₂) 404 and the sixth transistor (Q₆) 412 to the second transistor (Q₂) 104 of the traditional 3L buck converter 200 is determined based on the load profile of the converter-assuming that the sum of the surface area of the second transistor (Q₂) 404 and the sixth transistor (Q₆) 412 equals the surface area of the second transistor (Q₂) 104.

In embodiments, the third transistor (Q₃) 406 and the seventh transistor (Q₇) 414 are configured such that the surface area of each transistor is half the surface area of the third transistor (Q₃) 202 of the traditional 3L buck converter 200. In embodiments, the third transistor (Q₃) 406 and the seventh transistor (Q₇) 414 are configured such that the surface area of each transistor is a fraction of the surface area of the third transistor (Q₃) 202 of the traditional 3L buck converter 200.

In such embodiments, the third transistor (Q₃) 406 and the seventh transistor (Q₇) 414 are configured such that the summation of the surface area of the two transistors is equal to the surface area of the third transistor (Q₃) 202 of the traditional 3L buck converter 200.

For example, in an embodiment, the surface area of the third transistor (Q₃) 406 equals T/N of the surface area of the third transistor (Q₃) 202 of the traditional 3L buck converter 200, where N is an integer greater than one and T is an integer greater than 0. The surface area of the seventh transistor (Q₇) 414 equals N−T/N of the surface area of the third transistor (Q₃) 202 of the traditional 3L buck converter 200.

As another example, in an embodiment, the surface area of the third transistor (Q₃) 406 equals half the surface area of the third transistor (Q₃) 202 of the traditional 3L buck converter 200 and the surface area of the seventh transistor (Q₇) 414 equals ½ of the surface area of the third transistor (Q₃) 202 of the traditional 3L buck converter 200.

In embodiments, the selection of the ratio for each of the third transistor (Q₃) 406 and the seventh transistor (Q₇) 414 to the third transistor (Q₃) 202 of the traditional 3L buck converter 200 is determined based on the load profile of the converter-assuming that the sum of the surface area of the third transistor (Q₃) 406 and the seventh transistor (Q₇) 414 equals the surface area of the third transistor (Q₃) 202.

In embodiments, the fourth transistor (Q₄) 408 and the eighth transistor (Q₈) 416 are configured such that the surface area of each transistor is half the surface area of the fourth transistor (Q₄) 204 of the traditional 3L buck converter 200. In embodiments, the fourth transistor (Q₄) 408 and the eighth transistor (Q₈) 416 are configured such that the surface area of each transistor is a fraction of the surface area of the fourth transistor (Q₄) 204 of the traditional 3L buck converter 200. In such embodiments, the fourth transistor (Q₄) 408 and the eighth transistor (Q₈) 416 are configured such that the summation of the surface area of the two transistors is equal to the surface area of the fourth transistor (Q₄) 204 of the traditional 3L buck converter 200.

For example, in an embodiment, the surface area of the fourth transistor (Q₄) 408 equals T/N of the surface area of the fourth transistor (Q₄) 204 of the traditional 3L buck converter 200, where N is an integer greater than one and T is an integer greater than 0. The surface area of the eighth transistor (Q₈) 416 equals N−T/N of the surface area of the fourth transistor (Q₄) 204 of the traditional 3L buck converter 200.

As another example, in an embodiment, the surface area of the fourth transistor (Q₄) 408 equals half the surface area of the fourth transistor (Q₄) 204 of the traditional 3L buck converter 200 and the surface area of the eighth transistor (Q₈) 416 equals half the surface area of the fourth transistor (Q₄) 204 of the traditional 3L buck converter 200.

In embodiments, the selection of the ratio for each of the fourth transistor (Q₄) 408 and the eighth transistor (Q₈) 416 to the fourth transistor (Q₄) 204 of the traditional 3L buck converter 200 is determined based on the load profile of the converter-assuming that the sum of the surface area of the fourth transistor (Q₄) 408 and the eighth transistor (Q₈) 416 equals the surface area of the fourth transistor (Q₄) 204.

In embodiments, the control terminals of the first transistor (Q) 302, the second transistor (Q₂) 304, the third transistor (Q₃) 306, and the fourth transistor (Q₄) 308 are independently controlled to switch each transistor between an ON and OFF states selectively using the control logic 330.

In embodiments, the 3L buck converter 400 is configurable to operate in at least two modes. In an embodiment, the first mode corresponds to the operation of the battery charging circuit during the high-current charging mode, and the second mode corresponds to the operation of the battery charging circuit during the low-current charging mode.

In the first mode, the switch resistance losses dominate. Thus, it would be advantageous to configure the switching element 420 to decrease the on-resistance of the high-side and low-side transistors of the 3L buck converter 400. Accordingly, in the first mode, the control logic 450 provides control signals to operate the first transistor (Q) 402, the second transistor (Q₂) 404, the third transistor (Q₃) 406, the fourth transistor (Q₄) 408, the fifth transistor (Q₅) 410, the sixth transistor (Q₆) 412, the seventh transistor (Q₇) 414, and the eighth transistor (Q₈) 416 between the ON and OFF states.

In this mode, the high-side and low-side transistors of the 3L buck converter 400 have the same effective transistor area as the high-side and the low-side transistors of the traditional 3L buck converter 200. Accordingly, the effective resistance of the high-side transistors in the 3L buck converter 400 is at its maximum configuration and equal to the resistance of the high-side transistor in the traditional 3L buck converter 200. Likewise, the effective resistance of the low-side transistors in the 3L buck converter 400 is at its maximum configuration and equal to the resistance of the low-side transistor in the traditional 3L buck converter 200.

In the second mode, the switch charge losses dominate. Thus, it would be advantageous to configure the switching element 420 to decrease the capacitance of the high-side and low-side transistors of the 3L buck converter 400. Accordingly, in the second mode, the control logic 450 provides control signals to operate the first transistor (Q) 402, the second transistor (Q₂) 404, the third transistor (Q₃) 406, and the fourth transistor (Q₄) 408 between the ON and OFF states and fully deactivate the fifth transistor (Q₅) 410, the sixth transistor (Q₆) 412, the seventh transistor (Q₇) 414, and the eighth transistor (Q₈) 416.

In this mode, the high-side and low-side transistors of the 3L buck converter 400 have a fraction (e.g., half) of the effective transistor area as the high-side and the low-side transistors of the traditional 3L buck converter 200. Accordingly, the effective capacitance of the high-side transistor in the 3L buck converter 400 is significantly reduced compared to the high-side transistor in the traditional 3L buck converter 200. Likewise, the effective capacitance of the low-side transistor in the 3L buck converter 400 is significantly reduced compared to the low-side transistor in the traditional 3L buck converter 200.

Advantageously, during the high-current charging mode, the transistor area is at its maximum, the transistor's ON resistance is at its minimum, and the switch resistance losses are at their minimum. Further, during the low-current charging mode, the transistor area is at its minimum, the transistor's capacitance is at its minimum, and the switch charge losses are at their minimum.

Thus, the control logic 450 can selectively operate the switching element 420 based on the mode of the battery charging circuit to have the most efficient operating conditions without sacrificing efficiency in one mode for the other.

It should be noted that in FIG. 4, the switching element 420 of the 3L buck converter 400 is shown to include four high-side transistors (i.e., the first transistor (Q₁) 402, the third transistor (Q₃) 406, the fifth transistor (Q₅) 410, and the seventh transistor (Q₇) 414) instead of the two high-side transistors (i.e., the first transistor (Q₁) 102 and the third transistor (Q₃) 202) in the switching element 220 of the traditional 3L buck converter 200. Likewise, the switching element 420 of the 3L buck converter 400 is shown to include four low-side transistors (i.e., the second transistor (Q₂) 404, the fourth transistor (Q₄) 408, the sixth transistor (Q₆) 412, and the eighth transistor (Q₈) 416) instead of the two low-side transistors (i.e., the second transistor (Q₂) 104 and the fourth transistor (Q₄) 204) in the switching element 220 of the traditional 3L buck converter 200. However, it should be appreciated that the number of high-side transistors and low-side transistors in the switching element 420 is non-limiting.

For example, although the switching element 420 is shown to have two high-side transistors and two low-side transistors, embodiments with a switching element with 2×N number of high-side and low-side transistors, where N is an integer greater than one are similarly contemplated. In such embodiments, each transistor within the N number of transistors has a common drain and a common source.

In such embodiments, the transistor area of each transistor can be equal to, for example, 1/N the transistor area of the high-side or low-side transistor in the switching element 220 of the traditional 3L buck converter 200. It is noted that the transistor area for each transistor does not have to be equal to 1/N and different surface areas for the transistors in each set are similarly contemplated.

In embodiments, control logic 450 is configured to operate all N number of transistors between the ON and OFF states in the first mode, and fewer than all N number of transistors for each of the high-side and low-side transistors between the ON and OFF states in the second mode, while fully deactivating the other transistors.

For example, in an embodiment, where each of the transistors in the traditional M-level buck converter (M being greater than two) is replaced by N number of transistors, the total number of transistors in the improved M-level buck converter is N×M. During the first mode, all N×M number of transistors are activated and switch between ON and OFF states based on the switching mode operation of the switching converter. However, during the second mode, based on the load profile, T number of transistors are activated and switch between ON and OFF states based on the switching mode operation of the switching converter, where T is less than N×M. In the second mode, N×M−T number of transistors are fully deactivated and do not participate in the switching operation.

Further, although a 2L buck converter 300 and a 3L buck converter 400 are disclosed herein, it should be appreciated that the embodiments disclosed can be similarly applied to any M-level buck converter, with M being an integer greater than one. In the traditional M-level buck converter, the original number of transistors equals 2×(M−1). In the proposed M-level buck converter, the number of transistors equals 2×N×(M−1), with N being an integer greater than one.

For each transistor in the switching element of the traditional M-level buck converter, the proposed M-level buck converter includes N number of transistors. The transistor area for each transistor in the proposed M-level buck converter is, for example, i/N the transistor area of the traditional M-level buck converter. It is noted that the transistor area for each transistor does not have to be equal to 1/N and different surface areas for the transistors in each set are similarly contemplated.

During the first mode of the battery charging circuit, corresponding to the high-current charging mode, the full set of transistors (i.e., 2×N×(M−1)) of the proposed M-level buck converter are configured to operate between the ON and OFF states.

However, during the second mode of the battery charging circuit, corresponding to the low-current charging mode, a subset of transistors equal to the original number of transistors (i.e., 2×(M−1)) is configured to operate between the ON and OFF states while the remaining number of transistors are fully deactivated. In embodiments, the control logic 450 is configured to determine which set of transistors to activate during the second mode based on the load profile of the converter.

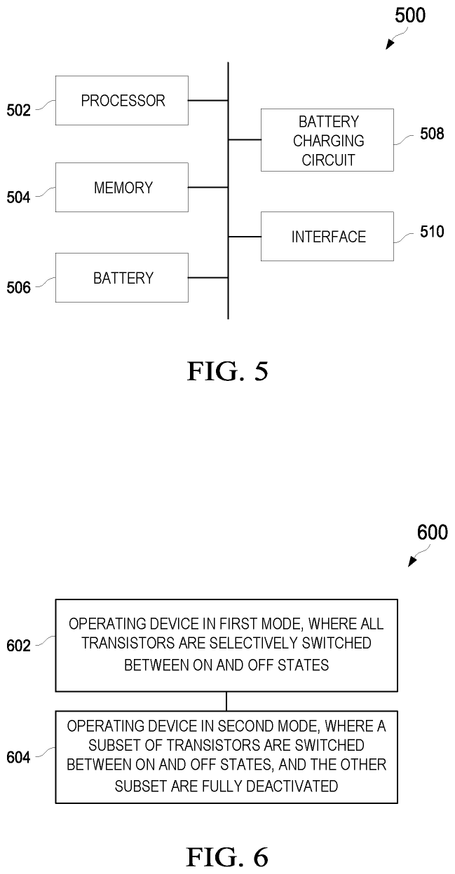

FIG. 5 illustrates a block diagram of an embodiment system 500. System 500 includes a processor 502, a memory 504, a battery 506, a battery charging circuit 508, and an interface 510, which may (or may not) be arranged as shown. System 500 may include additional components not shown, such as long-term storage (e.g., non-volatile memory, etc.), a bus system (i.e., control, status, data, etc. bus) to couple the various components of the device, security and encryption modules (e.g., trusted platform modules (TPM), etc.), or the like.

In embodiments, system 500 is an electronic device, such as a smartphone, smartwatch, wearable device, tablet, laptop, or any other portable battery-operated device. Although one of each (i.e., the processor 502, the memory 504, the battery 506, the battery charging circuit 508, and the interface 510) is shown in FIG. 5, the number of components is not limiting, and greater numbers are similarly contemplated in other embodiments.

Processor 502 may be any component or collection of components adapted to perform computations or other processing-related tasks. In embodiments, processor 502 is an application processor, a microcontroller, a digital signal processor, a graphics processing unit, or a combination thereof.

Memory 504 may be any component or collection of components adapted to store programming or instructions for execution by processor 502. In an embodiment, memory 504 includes a non-transitory computer-readable medium.

Battery 506 provides a power source for the operation and portability of system 500. The battery charging circuit 508 may include one or more multi-level buck converters to allow fast charging of the battery 506 using parallel charging circuits. In embodiments, the battery charging circuit 508 may use multi-level buck converters for charging the battery 506.

Battery 506 is configured to be charged using the battery charging circuit 508 and interface 510, such as through inductive charging by transferring power from a charging pad or a base station to system 500. In embodiments, battery charging circuit 508 and interface 510 allow the battery 506 to be charged using a wired interface.

The battery charging circuit 508 may be any component or collection of components that manage and control the distribution, conversion, and regulation of power in system 500. In embodiments, a multi-level buck converter or at least portions thereof are part of the battery charging circuit 508. The battery charging circuit 508 is configured to efficiently manage the power supply and consumption of various components within system 500.

In various embodiments, battery charging circuit 508 is configured to regulate supply voltage to various components of the system 500, control the operation of the multi-level buck converter, and control the charging, discharging, and monitoring of the operations of battery 506. In embodiments, battery charging circuit 508 includes a controller. In embodiments, the battery charging circuit 508 is part of a power management integrated circuit (PMIC). In embodiments, the instructions comprising the operation of system 500 are executed by processor 502.

Interface 510 may be any component or collection of components that allow processor 502 to communicate with other devices/components or a user. For example, interface 510 may be adapted to receive wireless power from an external source using a transceiver circuit and antennas. Further, interface 510 may include circuitry that allows system 500 to communicate signals externally or internally within the system 500 or a user.

FIG. 6 illustrates a flow chart of an embodiment method 600 for operating system 500 with an M-level buck converter. In the traditional M-level buck converter, with M being greater than one, the original number of transistors equals 2×(M−1). In the proposed M-level buck converter, the number of transistors equals 2×N×(M−1), where N is an integer greater than one.

For each transistor in the switching element of the traditional M-level buck converter, the proposed M-level converter includes N number of transistors. The transistor area for each transistor in the proposed M-level buck converter is 1/N the transistor area of the traditional multi-level buck converter.

At step 602, during the first mode of the proposed M-level buck converter of a battery charging circuit 508, a control logic provides control signals to the full set of transistors of the proposed M-level buck converter (i.e., 2×N×(M−1)) to operate the transistors between the ON and OFF states. In embodiments, the first mode corresponds to the high-current charge of the battery charging circuit 508.

In the first mode, the switch resistance losses dominate. Thus, the effective on-resistance (R_{ds} (ON)) of the transistors in the switching element of the proposed M-level buck converter are at its minimum and equal to the resistance in the traditional M-level buck converter.

At step 604, during a second mode of the proposed M-level buck converter of the battery charging circuit 508, a control logic provides control signals to a subset of transistors equal to the original number of transistors (i.e., 2×(M−1)) to operate between the ON and OFF states while the remaining number of transistors are fully deactivated. In embodiments, the second mode corresponds to the low-current charge mode of the battery charging circuit 508.

In the second mode, the switch charge losses dominate. Thus, the effective capacitance of the transistors in the switching element of the proposed M-level buck converter is at its minimum, resulting in reduced switch charge losses compared to the traditional M-level buck converter.

Advantageously, during the high-current charging mode, the transistor area is at its maximum, the transistor's ON resistance is at its minimum, and the switch resistance losses are at their minimum. Further, during the low-current charging mode, the transistor area is at its minimum, the transistor's capacitance is at its minimum, and the switch charge losses are at their minimum.

A first aspect relates to a method of operating an M-level buck converter comprising 2×N×(M−1) number of transistors. M and N are greater than one. A battery charging circuit includes the M-level buck converter. The method includes operating the M-level buck converter in a first mode of the battery charging circuit corresponding to a high-current charge mode. In the first mode, 2×N×(M−1) number of transistors are switched ON and OFF. The method further includes operating the M-level buck converter in a second mode of the battery charging circuit corresponding to a low-current charge mode. In the second mode, 2×(M−1) number of transistors are switched ON and OFF and 2×N×(M−1)−2×(M−1) number of transistors are fully deactivated.

In a first implementation form of the method according to the first aspect as such, the M-level buck converter has a multiple of N number of transistors greater than a second M-level buck converter with 2×(M−1) number of transistors. Each transistor in the M-level buck converter has a transistor area 1/N of each transistor in the second M-level buck converter.

In a second implementation form of the method according to the first aspect as such or any preceding implementation form of the first aspect, in the first mode, switch resistance losses in the M-level buck converter are equal to switch resistance losses in the second M-level buck converter. In the second mode, switch charge losses are reduced in reference to switch charge losses in the second M-level buck converter.

In a third implementation form of the method according to the first aspect as such or any preceding implementation form of the first aspect, the M-level buck converter is a two-level (2L) buck converter having four total transistors. All four transistors operate in a first switch-mode power supply configuration during the first mode. A first pair of transistors operates in a second switch-mode power supply configuration during the second mode. A second pair of transistors are fully deactivated in the second switch-mode power supply configuration.

In a fourth implementation form of the method according to the first aspect as such or any preceding implementation form of the first aspect, the M-level buck converter is a three-level (3L) buck converter having six total transistors. All six transistors operate in a first switch-mode power supply configuration during the first mode. A first set of three transistors operates in a second switch-mode power supply configuration during the second mode. A second set of three transistors is fully deactivated in the second switch-mode power supply configuration.

In a fifth implementation form of the method according to the first aspect as such or any preceding implementation form of the first aspect, the method further includes controlling, by a controller coupled to the M-level buck converter, an operation of the 2×N×(M−1) number of transistors in the first mode and the second mode.

In a sixth implementation form of the method according to the first aspect as such or any preceding implementation form of the first aspect, the method further includes selectively activating and deactivating the 2×N×(M−1) number of transistors in the first mode. The method further includes selectively activating and deactivating the 2×(M−1) number of transistors and fully deactivating the 2×N×(M−1)−2×(M−1) number of transistors in the second mode.

A second aspect relates to an M-level buck converter of a battery charging circuit, M being greater than one, the M-level buck converter includes 2×N×(M−1) number of transistors, N being greater than one. The M-level buck converter is configured to operate in a first mode and a second mode. The first mode corresponds to a high-current charge mode of the battery charging circuit. The second mode corresponds to a low-current charge mode of the battery charging circuit. In the first mode, 2×N×(M−1) number of transistors are switched ON and OFF. In the second mode, 2×(M−1) number of transistors are switched ON and OFF, and 2×N×(M−1)−2×(M−1) number of transistors are fully deactivated.

In a first implementation form of the M-level buck converter according to the second aspect as such, the M-level buck converter has a multiple of N number of transistors greater than a second M-level buck converter with 2×(M−1) number of transistors, each transistor in the M-level buck converter has a transistor area 1/N of each transistor in the second M-level buck converter.

In a second implementation form of the M-level buck converter according to the second aspect as such or any preceding implementation form of the second aspect, in the first mode, switch resistance losses in the M-level buck converter are equal to switch resistance losses in the second M-level buck converter. In the second mode, switch charge losses are reduced in reference to switch charge losses in the second M-level buck converter.

In a third implementation form of the M-level buck converter according to the second aspect as such or any preceding implementation form of the second aspect, the M-level buck converter is a two-level (2L) buck converter having four total transistors. All four transistors operate in a first switch-mode power supply configuration during the first mode. A first pair of transistors operates in a second switch-mode power supply configuration during the second mode and a second pair of transistors are fully deactivated in the second switch-mode power supply configuration.

In a fourth implementation form of the M-level buck converter according to the second aspect as such or any preceding implementation form of the second aspect, the M-level buck converter is a three-level (3L) buck converter having six total transistors. All six transistors operate in a first switch-mode power supply configuration during the first mode. A first set of three transistors are operating in a second switch-mode power supply configuration during the second mode and a second set of three transistors are fully deactivated in the second switch-mode power supply configuration.

In a fifth implementation form of the M-level buck converter according to the second aspect as such or any preceding implementation form of the second aspect, the M-level buck converter is coupled to a controller providing control signals to the 2×N×(M−1) number of transistors to control an operation of the 2×N×(M−1) number of transistors in the first mode and the second mode.

In a sixth implementation form of the M-level buck converter according to the second aspect as such or any preceding implementation form of the second aspect, the controller is configured to selectively activate and deactivate the 2×N×(M−1) number of transistors in the first mode and selectively activate and deactivate the 2×(M−1) number of transistors and fully deactivating the 2×N×(M−1)−2×(M−1) number of transistors in the second mode.

A third aspect relates to a system. The system includes a battery and a battery charging circuit. The battery charging circuit includes an M-level buck converter, M being greater than one. The M-level buck converter includes 2×N×(M−1) number of transistors, N being greater than one. The M-level buck converter is configured to operate in a first mode and a second mode. The first mode corresponds to a high-current charge mode of the battery charging circuit. The second mode corresponds to a low-current charge mode of the battery charging circuit. In the first mode, 2×N×(M−1) number of transistors are switched ON and OFF. In the second mode, 2×(M−1) number of transistors are switched ON and OFF, and 2×N×(M−1)−2×(M−1) number of transistors are fully deactivated.

In a first implementation form of the system according to the third aspect as such, the M-level buck converter has a multiple of N number of transistors greater than a second M-level buck converter with 2×(M−1) number of transistors. Each transistor in the M-level buck converter has a transistor area 1/N of each transistor in the second M-level buck converter.

In a second implementation form of the system according to the third aspect as such or any preceding implementation form of the third aspect, in the first mode, switch resistance losses in the M-level buck converter are equal to switch resistance losses in the second M-level buck converter. In the second mode, switch charge losses are reduced in reference to switch charge losses in the second M-level buck converter.

In a third implementation form of the system according to the third aspect as such or any preceding implementation form of the third aspect, the M-level buck converter is a two-level (2L) buck converter having four total transistors. All four transistors operate in a first switch-mode power supply configuration during the first mode. A first pair of transistors operate in a second switch-mode power supply configuration during the second mode and a second pair of transistors are fully deactivated in the second switch-mode power supply configuration.

In a fourth implementation form of the system according to the third aspect as such or any preceding implementation form of the third aspect, the M-level buck converter is a three-level (3L) buck converter having six total transistors. All six transistors operate in a first switch-mode power supply configuration during the first mode. A first set of three transistors operates in a second switch-mode power supply configuration during the second mode, and a second set of three transistors are fully deactivated in the second switch-mode power supply configuration.

In a fifth implementation form of the system according to the third aspect as such or any preceding implementation form of the third aspect, the system further includes a controller configured to provide control signals to the 2×N×(M−1) number of transistors to control an operation of the 2×N×(M−1) number of transistors in the first mode and the second mode.

A fourth aspect relates to a method of operating an M-level buck converter in a battery charging circuit, the M-level buck converter comprising 2×N×(M−1) number of transistors, M and N being greater than one. The method includes operating the M-level buck converter in a first mode of the battery charging circuit corresponding to a high-current charge mode, wherein the 2×N×(M−1) number of transistors are switched ON and OFF. The method further includes operating the M-level buck converter in a second mode of the battery charging circuit corresponding to a low-current charge mode, wherein at least 2×(M−1) but less than 2×N×(M−1) number of transistors are switched ON and OFF.

In a first implementation form of the method according to the first aspect as such, the number of transistors selected to switch ON and OFF during the second mode is based on the load profile of the load coupled to the M-level buck converter.

A fifth aspect relates to an M-level buck converter of a battery charging circuit, M being greater than one, the M-level buck converter includes 2×N×(M−1) number of transistors, N being greater than one. The M-level buck converter is configured to operate in a first mode and a second mode. The first mode corresponds to a high-current charge mode of the battery charging circuit. The second mode corresponds to a low-current charge mode of the battery charging circuit. In the first mode, 2×N×(M−1) number of transistors are switched ON and OFF. In the second mode, at least 2×(M−1) but less than 2×N×(M−1) number of transistors are switched ON and OFF.

In a first implementation form of the M-level buck converter according to the second aspect as such, the number of transistors selected to switch ON and OFF during the second mode is based on the load profile of the load coupled to the M-level buck converter.

A third aspect relates to a system. The system includes a battery and a battery charging circuit. The battery charging circuit includes an M-level buck converter, M being greater than one. The M-level buck converter includes 2×N×(M−1) number of transistors, N being greater than one. The M-level buck converter is configured to operate in a first mode and a second mode. The first mode corresponds to a high-current charge mode of the battery charging circuit. The second mode corresponds to a low-current charge mode of the battery charging circuit. In the first mode, 2×N×(M−1) number of transistors are switched ON and OFF. In the second mode, at least 2×(M−1) but less than 2×N×(M−1) number of transistors are switched ON and OFF.

In a first implementation form of the system according to the third aspect as such, the number of transistors selected to switch ON and OFF during the second mode is based on the load profile of the load coupled to the M-level buck converter.

It is noted that all steps outlined in the flow chart are not necessarily required and can be optional. Further, changes to the arrangement of the steps, removal of one or more steps and path connections, and addition of steps and path connections are similarly contemplated.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. 2×N×(M−1)2×N×(M−1)2×(M−1)2×N×(M−1)1. A method of operating an M-level buck converter in a battery charging circuit, the M-level buck converter comprising number of transistors, M and N being greater than one, the method comprising:
2×N×(M−1)2×N×(M−1)2×(M−1)2×N×(M−1) operating the M-level buck converter in a first mode of the battery charging circuit corresponding to a high-current charge mode, wherein the number of transistors are switched ON and OFF; and
2×N×(M−1)2×N×(M−1)2×(M−1)2×N×(M−1) operating the M-level buck converter in a second mode of the battery charging circuit corresponding to a low-current charge mode, wherein at least but less than number of transistors are switched ON and OFF.

2. The method of claim 1, wherein the M-level buck converter has a multiple of N number of transistors greater than a second M-level buck converter with 2×(M−1) number of transistors, each transistor in the M-level buck converter has a transistor area 1/N of each transistor in the second M-level buck converter.

3. The method of claim 2, wherein, in the first mode, switch resistance losses in the M-level buck converter are equal to switch resistance losses in the second M-level buck converter, and wherein, in the second mode, switch charge losses are reduced in reference to switch charge losses in the second M-level buck converter.

4. The method of claim 1, wherein the M-level buck converter is a two-level (2L) buck converter having four total transistors, wherein all four transistors are operating in a first switch-mode power supply configuration during the first mode, and wherein a first pair of transistors are activated in a second switch-mode power supply configuration during the second mode, and a second pair of transistors are fully deactivated in the second switch-mode power supply configuration.

5. The method of claim 1, wherein the M-level buck converter is a three-level (3L) buck converter having six total transistors, wherein all six transistors are activated in a first switch-mode power supply configuration during the first mode, and wherein a first set of three transistors are activated in a second switch-mode power supply configuration during the second mode, and a second set of three transistors are fully deactivated in the second switch-mode power supply configuration.

6. The method of claim 1, further comprising controlling, by a controller coupled to the M-level buck converter, an operation of the 2×N×(M−1) number of transistors in the first mode and the second mode.
2×N×(M−1)2×(M−1)2×N×(M−1)−2×(M−1)7. The method of claim 1, further comprising:
2×N×(M−1)2×(M−1)2×N×(M−1)−2×(M−1) selectively activating and deactivating the number of transistors in the first mode; and
2×N×(M−1)2×(M−1)2×N×(M−1)−2×(M−1) selectively activating and deactivating the number of transistors and fully deactivating the number of transistors in the second mode.
2×N×(M−1)2×N×(M−1)2×(M−1)2×N×(M−1)−2×(M−1)8. An M-level buck converter of a battery charging circuit, M being greater than one, the M-level buck converter comprising:
2×N×(M−1)2×N×(M−1)2×(M−1)2×N×(M−1)−2×(M−1) number of transistors, N being greater than one, wherein the M-level buck converter is configured to operate in a first mode and a second mode, the first mode corresponding to a high-current charge mode of the battery charging circuit, the second mode corresponding to a low-current charge mode of the battery charging circuit,
2×N×(M−1)2×N×(M−1)2×(M−1)2×N×(M−1)−2×(M−1) wherein, in the first mode, number of transistors are switched ON and OFF, and
2×N×(M−1)2×N×(M−1)2×(M−1)2×N×(M−1)−2×(M−1) wherein, in the second mode, number of transistors are switched ON and OFF, and number of transistors are fully deactivated.

9. The M-level buck converter of claim 8, wherein the M-level buck converter has a multiple of N number of transistors greater than a second M-level buck converter with 2×(M−1) number of transistors, each transistor in the M-level buck converter has a transistor area 1/N of each transistor in the second M-level buck converter.

10. The M-level buck converter of claim 9, wherein, in the first mode, switch resistance losses in the M-level buck converter are equal to switch resistance losses in the second M-level buck converter, and wherein, in the second mode, switch charge losses are reduced in reference to switch charge losses in the second M-level buck converter.

11. The M-level buck converter of claim 8, wherein the M-level buck converter is a two-level (2L) buck converter having four total transistors, wherein all four transistors are activated in a first switch-mode power supply configuration during the first mode, and wherein a first pair of transistors are activated in a second switch-mode power supply configuration during the second mode, and a second pair of transistors are fully deactivated in the second switch-mode power supply configuration.

12. The M-level buck converter of claim 8, wherein the M-level buck converter is a three-level (3L) buck converter having six total transistors, wherein all six transistors are activated in a first switch-mode power supply configuration during the first mode, and wherein a first set of three transistors are activated in a second switch-mode power supply configuration during the second mode, and a second set of three transistors are fully deactivated in the second switch-mode power supply configuration.

13. The M-level buck converter of claim 8, wherein the M-level buck converter is coupled to a controller providing control signals to the 2×N×(M−1) number of transistors to control an operation of the 2×N×(M−1) number of transistors in the first mode and the second mode.
2×N×(M−1)2×(M−1)2×N×(M−1)−2×(M−1)14. The M-level buck converter of claim 13, wherein the controller is configured to:
2×N×(M−1)2×(M−1)2×N×(M−1)−2×(M−1) selectively activate and deactivate the number of transistors in the first mode; and
2×N×(M−1)2×(M−1)2×N×(M−1)−2×(M−1) selectively activate and deactivate the number of transistors and fully deactivating the number of transistors in the second mode. 2×N×(M−1)2×N×(M−1)2×(M−1)2×N×(M−1)−2×(M−1)15. A system, comprising:
2×N×(M−1)2×N×(M−1)2×(M−1)2×N×(M−1)−2×(M−1) a battery; and
2×N×(M−1)2×N×(M−1)2×(M−1)2×N×(M−1)−2×(M−1) a battery charging circuit comprising an M-level buck converter, M being greater than one, the M-level buck converter comprising:
$$2 \times N \times ( M - 1 ) 2 \times N \times ( M - 1 ) 2 \times ( M - 1 ) 2 \times N \times ( M - 1 ) - 2 \times ( M - 1 )$$
number of transistors, N being greater than one, wherein the M-level buck converter is configured to operate in a first mode and a second mode, the first mode corresponding to a high-current charge mode of the battery charging circuit, the second mode corresponding to a low-current charge mode of the battery charging circuit,
$$2 \times N \times ( M - 1 ) 2 \times N \times ( M - 1 ) 2 \times ( M - 1 ) 2 \times N \times ( M - 1 ) - 2 \times ( M - 1 )$$
wherein, in the first mode, number of transistors are switched ON and OFF, and
$$2 \times N \times ( M - 1 ) 2 \times N \times ( M - 1 ) 2 \times ( M - 1 ) 2 \times N \times ( M - 1 ) - 2 \times ( M - 1 )$$
wherein, in the second mode, number of transistors are switched ON and OFF, and number of transistors are fully deactivated.

16. The system of claim 15, wherein the M-level buck converter has a multiple of N number of transistors greater than a second M-level buck converter with 2×(M−1) number of transistors, each transistor in the M-level buck converter has a transistor area 1/N of each transistor in the second M-level buck converter.

17. The system of claim 16, wherein, in the first mode, switch resistance losses in the M-level buck converter are equal to switch resistance losses in the second M-level buck converter, and wherein, in the second mode, switch charge losses are reduced in reference to switch charge losses in the second M-level buck converter.

18. The system of claim 15, wherein the M-level buck converter is a two-level (2L) buck converter having four total transistors, wherein all four transistors are activated in a first switch-mode power supply configuration during the first mode, and wherein a first pair of transistors are activated in a second switch-mode power supply configuration during the second mode, and a second pair of transistors are fully deactivated in the second switch-mode power supply configuration.

19. The system of claim 15, wherein the M-level buck converter is a three-level (3L) buck converter having six total transistors, wherein all six transistors are activated in a first switch-mode power supply configuration during the first mode, and wherein a first set of three transistors are activated in a second switch-mode power supply configuration during the second mode, and a second set of three transistors are fully deactivated in the second switch-mode power supply configuration.

20. The system of claim 15, further comprising a controller, the controller configured to provide control signals to the 2×N×(M−1) number of transistors to control an operation of the 2×N×(M−1) number of transistors in the first mode and the second mode.
